(19) United States
(12) Patent Application Publication
(10) Pub. No.: US 2008/0132288 A1
(43) Pub. Date: Jun. 5, 2008

(54) Portable device

(75) Inventor: Atsushi Misawa, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/987,726

(22) Filed: Dec. 4, 2007

(30) Foreign Application Priority Data
Dec. 4, 2006 (JP) 2006-327446

(51) Int. Cl. H04B 1/38

(52) U.S. Cl. 455/566

(57) ABSTRACT

The present invention provides a portable device which can easily (by one action) bring the display device into a use state from a stored state when a display device is used in a vertical orientation or the display device is used in a horizontal orientation, and can make an exclusive operation part usable in each use state, can hide an unnecessary operation part to enhance operability, or can show an exclusive appearance on a surface.

### BACKGROUND OF THE INVENTION

1. Field of the Invention

The present invention relates to portable device such as a cellular phone, and particularly to portable device including a slide mechanism.

2. Description of the Related Art

As portable device, a folding type of portable device in which two enclosures that are an enclosure having a display device and an enclosure having an operation part are linked to be openable and closable via a hinge, and a slide type of portable device in which two enclosures are linked to be openable and closable via a slide mechanism are known. Such portable device can be brought into a compact stored state convenient to carry by overlaying the enclosure having a display device and the enclosure having an operation part on each other.

In such storable portable device, there is the one equipped with a television receiving function. Generally, a display device of storable portable device is in a vertically-oriented shape, but there may be a case in which the display device is desired to be horizontally-oriented to enhance visibility for information displayed in a horizontal orientation such as a television image.

In order to solve this, Japanese Patent Application Laid-Open No. 2001-156893 proposes communication device in which a display unit portion is made rotatable, display can be made vertically-oriented or horizontally-oriented with respect to an operation part enclosure, and the display of the display part is switched to be vertically-oriented and horizontally-oriented with the rotation of the display unit portion.

Japanese Patent Application Laid-Open No. 2005-38217 proposes portable device in which a main body part and a flip part are deformable in various forms by jointing the main body part and the flip part to each other to be rotatable by using a hinge having three axes of rotation.

In such storable portable device, only one kind of operation part is generally used, but it is sometimes efficient to use another operation part in accordance with the functions to be used such as a call function and a television function.

In order to solve this, Japanese Patent Application Laid-Open No. 2002-330198 proposes a cellular phone in which different operation parts appear in correspondence with opening and closing a flip.

### SUMMARY OF THE INVENTION

However, the portable device disclosed in the above described Patent Documents has the following disadvantage. Specifically, the communication device disclosed in Japanese Patent Application Laid-Open No. 2001-156893 has the problem that a plurality of operations are required and the operations are complicated when the device is switched into a state in which the display device is used in a horizontal orientation from a state in which it is stored with two enclosures folded.

The portable device disclosed in Japanese Patent Application Laid-Open No. 2005-38217 has the problem of having necessity of using an expensive and complicated mechanism called a hinge having a plurality of axes, and also has the problem that when the display device is made horizontally-oriented, the operation portion and the letters on the enclosure are also horizontally-oriented at the same time when the display device is horizontally oriented, and therefore, it becomes difficult to operate. It also has the problem of confusion since the appearance is the same.

The cellular phone disclosed in Japanese Patent Application Laid-Open No. 2002-330198 has the problem that a display device cannot be provided at an entire enclosure, and the display device becomes small.

The present invention is made in view of the above circumstances, and has its object to provide portable device which can easily (by one action) bring the display device into a use state from a stored state when a display device is used in a vertical orientation or the display device is used in a horizontal orientation, and can make an exclusive operation part usable in each use state, can hide an unnecessary operation part to enhance operability, or can show an exclusive appearance on a surface.

In order to attain the above-described object, portable device according to the present invention includes a first enclosure including a first operation part, a second enclosure including a display part, a third enclosure, and a joint mechanism which joints the first enclosure, the second enclosure and the third enclosure respectively, and joints the second enclosure movably with respect to the first enclosure from a first position in which a silhouette of the second enclosure is overlaid on the first enclosure to a second position and a third position differing from each other, wherein in the first position, the joint mechanism integrally joints the second enclosure so as to be overlaid on silhouettes of the first enclosure and the third enclosure, when the second enclosure moves to the second position from the first position, the joint mechanism causes the third enclosure to be exposed by restricting a moving amount of the third enclosure accompanying the movement of the second enclosure to zero or to be smaller than a moving amount of the second enclosure, and when the second enclosure moves to the third position from the first position, the joint mechanism causes the first operation part to be exposed in an operable state by restricting the moving amount of the third enclosure accompanying the movement of the second enclosure to be the same as that of the second enclosure or to be smaller than the moving amount of the second enclosure.

As a result, by hiding an unnecessary operation part in each use state, operability is enhanced and the exclusive appearance can be shown on the surface.

In order to attain the above described object, a portable device according to the present invention includes a first enclosure including a first operation part, a second enclosure including a display part, a third enclosure including a second operation part, and a joint mechanism which joints the first enclosure, the second enclosure and the third enclosure respectively, and joints the second enclosure movably with respect to the first enclosure from a first position in which a silhouette of the second enclosure is overlaid on the first enclosure to a second position and a third position differing from each other, wherein in the first position, the joint mechanism integrally joints the second enclosure so as to be overlaid on silhouettes of the first enclosure and the third enclosure, when the second enclosure moves to the second position from the first position, the joint mechanism causes the second operation part to be exposed in an operable state by restricting a moving amount of the third enclosure accompanying the movement of the second enclosure to zero or to be smaller than a moving amount of the second enclosure, and when the second enclosure moves to the third position from the first position, the joint mechanism causes the first operation part to be exposed in an operable state by restricting the moving amount of the third enclosure accompanying the movement of the second enclosure to be the same as that of the second enclosure or to be smaller than the moving amount of the second enclosure.

As a result, only the necessary operation parts are exposed in the first position, the second position and the third position, and therefore, operability can be enhanced.

The joint mechanism (link mechanism) may be constituted so that when the second enclosure moves to the second position from the first position with respect to the first enclosure, the second enclosure may move parallel in a first direction, and when the second enclosure moves to the third position from the first position with respect to the first enclosure, the second enclosure may move parallel in a second direction differing from the first direction.

As a result, the second enclosure can be easily moved to the second position from the first position and to the third position from the first position.

The joint mechanism may use a parallel-linking mechanism as a mechanism for the second enclosure to perform parallel movement in one direction of the parallel movement in two directions that are the first direction and the second direction.

As a result, parallel movement can be realized with a simple and reliable mechanism.

The joint mechanism (link mechanism) may be constituted so that when the second enclosure moves to the second position from the first position with respect to the first enclosure, the second enclosure may perform parallel movement, and when the second enclosure moves to the third position from the first position with respect to the first enclosure, the second enclosure may perform rotational movement.

At this time, it is preferable to further include a restriction mechanism restricting movement of the second enclosure, and the restriction mechanism preferably restrict the motion of the second enclosure so as to allow parallel movement and rotational movement of the second enclosure in the first position, allow only the parallel movement of the second enclosure in the second position, and allow only the rotational movement of the second enclosure in the third position.

As a result, movement of the second enclosure is restricted so as not be able to perform unnecessary motion, and therefore, the second enclosure can be moved more easily to the second position from the first position and to the third position from the first position.

The joint mechanism (link mechanism) may be constituted so that when the second enclosure moves to the second position from the first position with respect to the first enclosure, the second enclosure performs rotational movement, and when the second enclosure moves to the third position from the first position with respect to the first enclosure, the second enclosure performs parallel movement.

At this time, it is preferable to include a restriction mechanism restricting movement of the second enclosure, and the restriction mechanism preferably restrict motion of the second enclosure so as to allow parallel movement and rotational movement of the second enclosure in the first position, allow only rotational movement of the second enclosure in the second position, and allow only parallel movement of the second enclosure in the third position.

Thereby, movement of the second enclosure is restricted so as not to be able to perform unnecessary motion, and therefore, the second enclosure can be moved more easily to the second position from the first position and to the third position from the first position.

A stop mechanism stopping the second enclosure with predetermined holding forces respectively in the first position, the second position and the third position may be included.

As a result, the second enclosure is stopped at each position, and therefore, an operation at each position is facilitated.

In order to attain the above described object, a portable device according to the present invention includes a first enclosure including a first operation part, a second enclosure including a display part, a third enclosure, and a joint mechanism which joints the first enclosure, the second enclosure and the third enclosure respectively, and joints the second enclosure movably with respect to the first enclosure from a first position in which a silhouette of the second enclosure is overlaid on the first enclosure to a second position and a third position differing from each other, wherein in the first position, the joint mechanism integrally joints the second enclosure so as to be overlaid on silhouettes of the first enclosure and the third enclosure, when the second enclosure moves to the second position from the first position, the joint mechanism causes the third enclosure to be exposed by restricting a moving amount of the third enclosure accompanying the movement of the second enclosure to zero or to be smaller than a moving amount of the second enclosure, and when the second enclosure moves to the third position from the first position, the joint mechanism causes the first operation part to be exposed in an operable state by restricting the moving amount of the third enclosure accompanying the movement of the second enclosure to be the same as the second enclosure or to be smaller than the moving amount of the second enclosure, and the portable device further includes a position detecting device capable of detecting which position of the first position, the second position and the third position the portable device is in, and a mode selecting device selecting a usable operation mode from a plurality of operation modes, and the mode selecting device automatically selects a usable operation mode from the plurality of operation modes based on a detection result of the position detecting device.

As a result, the portable device in which the operation mode in each position is automatically selected, and a user does not have to perform a complicated operation can be provided.

The display part may be provided in the second enclosure so that its longitudinal direction corresponds to a longitudinal direction of the second enclosure, one of the plurality of operation modes may be a television viewing and listening mode, a moving image reproduction mode or a game mode, and when a screen of the display part is held to be seen in a horizontal orientation, the first operation part exposed below the screen may be made a television operation part, a moving image reproduction operation part or a game operation part.

As a result, television viewing and listening, moving image reproduction or a game which is suitable for a horizontal orientation can be performed with the display horizontally-oriented, and an operation can be performed in a lower portion of the display.

A camera device which takes an image of a subject, and an image-taking lens used in the camera device exposed from a back of the second enclosure only when the second enclosure is moved parallel in a longitudinal direction may be included, and the mode selecting device may make it possible to select a camera mode actuating the camera device only when the second enclosure is in the second position to which the second enclosure is moved parallel in the longitudinal direction.

As a result, the lens is exposed in the second position, and image-taking by a camera device can be performed. The image-taking lens is not exposed in the first position and the third position, and the image-taking lens can be protected from damage and contamination.

A telephone device may be included, when the second enclosure is in the first position, the mode selecting device may select a waiting mode waiting for arrival of a telephone call from the plurality of operation modes, and only when the second enclosure is in the second position to which the second enclosure is moved parallel in the longitudinal direction, the mode selecting device may make it possible to select a call mode allowing a call by the telephone function.

As a result, the telephone function with favorable usability can be realized.

According to the present invention, the operation member suitable for the mode using the display of the portable device in the vertical orientation is exposed when the display of the portable device is used in the vertical orientation, and the operation member suitable for the mode using the display in the horizontal orientation is exposed when the display is used in the horizontal orientation, whereby the portable device easy for a user to operate can be provided.

### BRIEF DESCRIPTION OF THE DRAWINGS

FIGS. 1A to 1C are perspective views of portable device 1 of a first embodiment according to the present invention seen from a front;

FIGS. 2A to 2C are perspective views of the portable device 1 seen from a rear side;

FIG. 3 is a system block diagram of the portable device 1;

FIG. 4 is an exploded perspective view of the portable device 1;

FIGS. 5A to 5D are views of the respective enclosures of the portable device 1 seen from a top side;

FIGS. 6A to 6C are views of the transition of slide movement of the portable device 1 to the second position from the first position seen from the top side;

FIGS. 7A to 7C are sectional views in the lines a to a′ of FIGS. 6A to 6C;

FIGS. 8A to 8C are views of the transition of rotational movement of the portable device 1 to the third position from the first position seen from the top side;

FIGS. 9A to 9C are sectional views in the lines b to b′ of FIGS. 8A to 8C;

FIG. 10 is a table showing states of ON and OFF of the first detection switch 16 and the second detection switch 34 in each of the positions;

FIG. 11 is a flowchart showing an operation state of the portable device 1;

FIG. 12 is an exploded perspective view of a third enclosure 30;

FIG. 13 is an exploded perspective view of the third enclosure 30;

FIG. 14 is a sectional view of a second operation part 31 and a first operation part 11;

FIGS. 15A to 15C are perspective views of the portable device 1 of a second embodiment of the present invention seen from a front;

FIGS. 16A to 16C are perspective views of the portable device 1 seen from a rear side;

FIG. 17 is an exploded perspective view of the portable device 1;

FIGS. 18A to 18C are views of the respective enclosures seen from top portions;

FIGS. 19A to 19C are views of transition of the vertical slide movement to the second position from the first position seen from the top side;

FIGS. 20A to 20C are views of the transition of the horizontal slide movement of the portable device 1 to the third position from the first position seen from the top side;

FIGS. 21A and 21B are perspective views of the portable device 1 seen from the front;

FIG. 22 is a view showing the third position of the portable device 1 of a third embodiment according to the present invention; and

FIG. 23 is a view of the third position of the portable device 1 of the third embodiment according to the present invention.

### DETAILED DESCRIPTION OF THE PREFERRED EMBODIMENTS

Hereinafter, preferred embodiments of portable device according to the present invention will be described with reference to the attached drawings.

### First Embodiment

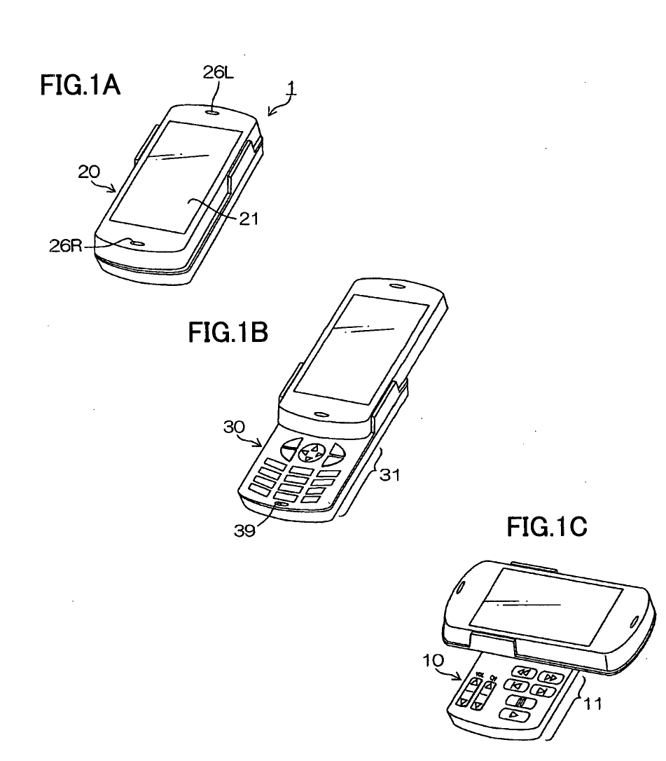

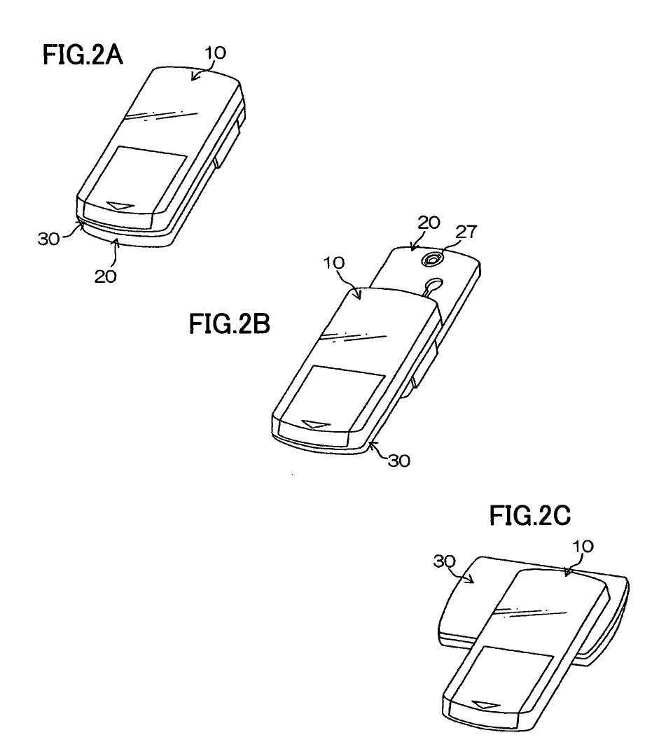

FIGS. 1A to 1C are perspective views of portable device 1 of a first embodiment according to the present invention seen from a front. FIG. 1A shows a first position that is a stored state, FIG. 1B shows a second position that is a state in which a display device is used in a vertical orientation. FIG. 1C shows a third position that is a state in which the display device is used in a horizontal orientation. FIGS. 2A to 2C are perspective views of the portable device 1 seen from a rear. FIG. 2A shows a first position. FIG. 2B shows a second position. FIG. 2C shows a third position.

The portable device 1 is portable device of which operation member is capable of being slid and stored such as a cellular phone, for example, and is constituted of a first enclosure 10, a second enclosure 20 and a third enclosure 30.

As shown in FIG. 1C, the first enclosure 10 is in a substantially rectangular parallelepiped shape, where a first operation part 11 constituted of a television operation button, a moving image reproduction button, a sound volume button and the like is placed. As shown in FIG. 1A, the second enclosure 20 is also in a substantially rectangular parallelepiped shape as the first enclosure 10, where a rectangular display 21 for displaying information such as an image, with a longitudinal direction aligned with a longitudinal direction of the enclosure, and speakers 26R and 26L outputting sound are placed, and an image-taking lens 27 located on a back side of the enclosure as shown in FIG. 2B is placed. As shown in FIG. 1B, the third enclosure 30 is in a substantially rectangular parallelepiped shape as the first enclosure 10, and in the third enclosure 30, a second operation part 31 constituted of a call button, a clearing button, a ten key, a shutter button and the like, and a microphone 39 which inputs voice at the time of telephone call are placed.

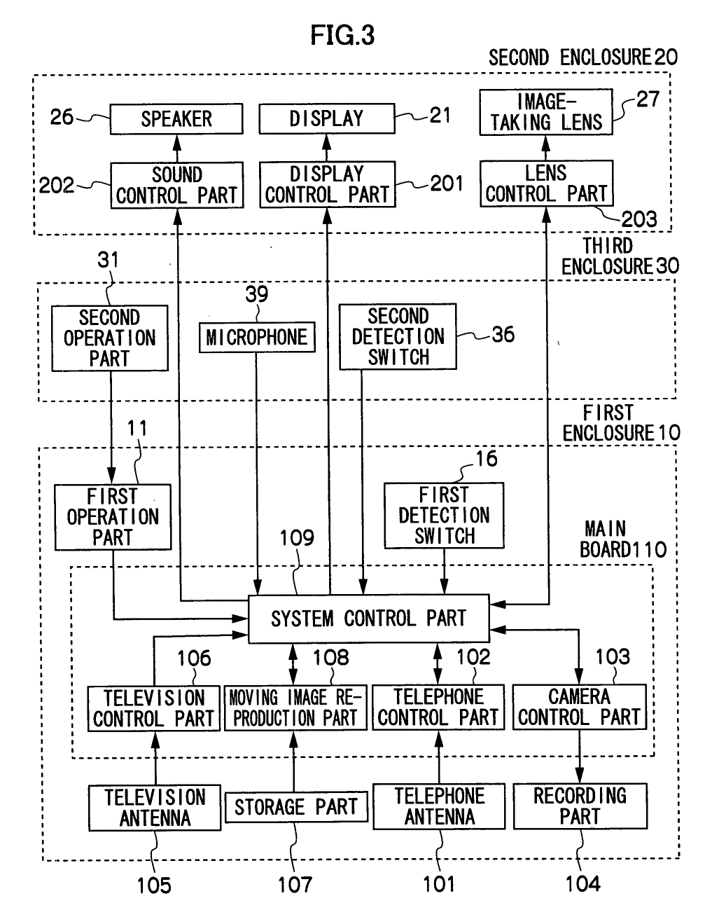

Next, by using FIG. 3, an internal configuration of the portable device 1 will be described. FIG. 3 is a system block diagram of the portable device 1.

The first enclosure 10 includes a first detection switch 16 for detecting which position of a first position, a second position and a third position the portable device 1 is in, a telephone antenna 101, a telephone control part 102 having a decoder, modulator and the like for transmitting and receiving a voice signal, a camera control part 103 taking an image of a subject via an image-taking lens 27, and digital-processing the taken image data, a recording part 104 in which taken data is stored, an television antenna 105, a television control part 106 including a tuner for receiving television, a decoder and the like, a storage part 107 including an attachable and detachable external media for storing moving image data, a moving image reproduction control part 108 including a signal processing circuit and the like for reproducing data of the moving image storage part 107, a system control part 109 selectively controlling each of the control parts, a main board 110 mounted with ICs and electronic components of these control parts, and a battery not shown, in addition to the first control part 11 shown in FIG. 1C.

The second enclosure 20 includes a display control part 201 including a driver and the like for displaying letters and images on the display 21, a voice output control part 202 including an amplifier or the like amplifying an output signal and controlling the speaker 26, and a lens control part 203 for changing a focus and a diaphragm of the lens 27, in addition to the display 21 and the speaker 26 shown in FIG. 1A and the image-taking lens 27 shown in FIG. 2B, and these ICs and electronic components are connected to the main board 110 by a flexible printed board not shown.

The third enclosure 30 is provided with a second detection switch 36 for detecting which position of the first position, the second position and the third position the portable device 1 is in, in addition to the second operation part 31 and the microphone 39 shown in FIG. 1B, and these ICs and electronic components are connected to the main board 110 by a flexible printed board not shown.

The portable device 1 thus configured can perform a call to an optional number, transmission and reception of an electronic mail and the like by using the second operation part 31 in the second position shown in FIG. 1B. In the second position, the microphone 39 is exposed, and its positional relationship is such that the microphone 39 is separated at a distance convenient for a call, whereby call is possible by using the telephone function by applying the speaker 26 and the microphone 39 to an ear and a mouth respectively, and favorable operability is provided. As shown in FIG. 2B, in the second position, the image-taking lens 27 is exposed, and by operating a shutter button of the operation part 31 with the lens pointed to a subject, whereby, image-taking is possible. On the other hand, as shown in FIGS. 2A and 2C, the image-taking lens 27 is not exposed in the first position and the third position, and therefore, the image-taking lens can be protected when it is not used.

In the third position shown in FIG. 1C, television and various moving images can be viewed and listened to by using the first operation part 11. In the third position, the display 21 is horizontally oriented, and an image of a horizontally oriented television broadcasting can be efficiently displayed. The first operation part 11 exposed in the third position includes an operation button exclusive for viewing and listening to television and moving images, and is convenient for use.

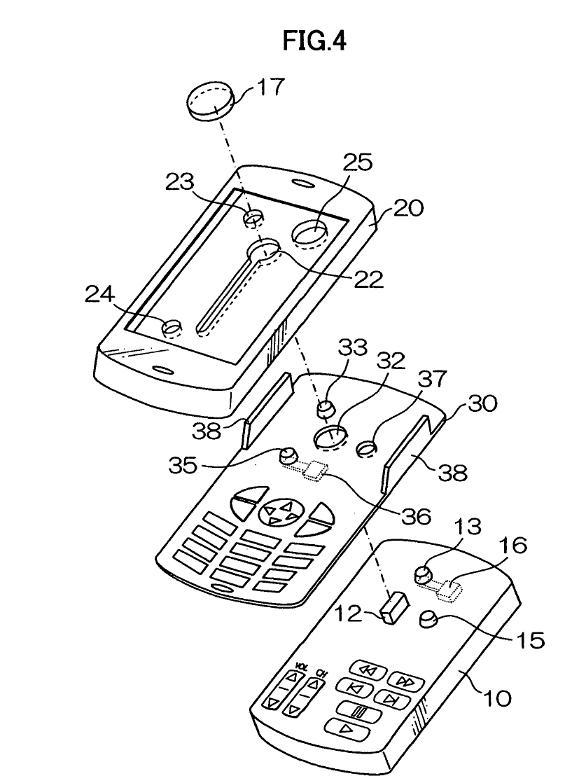

Next, a joint mechanism (link mechanism) of the portable device 1 of the first embodiment according to the present invention will be described by using FIG. 4. FIG. 4 is an exploded perspective view of the portable device 1, where the second enclosure 20 is illustrated so that the bottom surface can be seen from the top portion by omitting the display 21 and the like.

As shown in FIG. 4, the first enclosure 10 is provided with a key 12 in a rectangular parallelepiped shape, a first lock pin 13, a first detection switch 16 for detecting whether the first lock pin 13 is pressed or not, and a second lock pin 15. The third enclosure 30 is provided with a round hole 32 for rotation, a third lock pin 33, a fourth lock pin 35, a second detection switch 36 for detecting whether the fourth lock pin 35 is pressed or not, a third round hole 37, and restriction plates 38 on both sides. The key 12 is rotatable inside the round hole 32 for rotation, and the hole diameter of the third round hole 37 is larger than the diameters of the first lock pin 13 and the second lock pin 15 so that the first lock pin 13 and the second lock pin 15 are fittable in it. The height of the restriction plates 38 is smaller than the thickness of the second enclosure 20.

A keyhole-shaped slit 22, a first round hole 23, a second round hole 24, and a round hole 25 for a lens for disposing a lens for image-taking are provided on a bottom surface portion of the second enclosure 20. The hole diameters of the first round hole 23 and the second round hole 24 are larger than the diameters of the third lock pin 33 and the fourth lock pin 35 so that the third lock pin 33 and the fourth lock pin 35 are fittable therein. The keyhole-shaped slit 22 is formed into a shape in which a round hole portion and a long hole portion are connected. The key 12 is rotatable inside the round hole portion, whereas the key 12 is slidable inside the long hole portion, and the width of the long hole portion is formed to be smaller than the key 12 in the long surface direction.

The key 12 provided on the first enclosure 10 is fitted and fixed to a slipping-off prevention cap 17 through the round hole 32 for rotation of the third enclosure and the keyhole-shape slit 22 of the second enclosure. The diameter of the slipping-off prevention cap 17 is larger than the round hole 32 for rotation and the round hole portion of the keyhole-shaped slit 22. Thus, the portable device 1 of the first embodiment according to the present invention has a constitution in which the first enclosure 10 and the second enclosure 20 are integrated to sandwich the third enclosure 30.

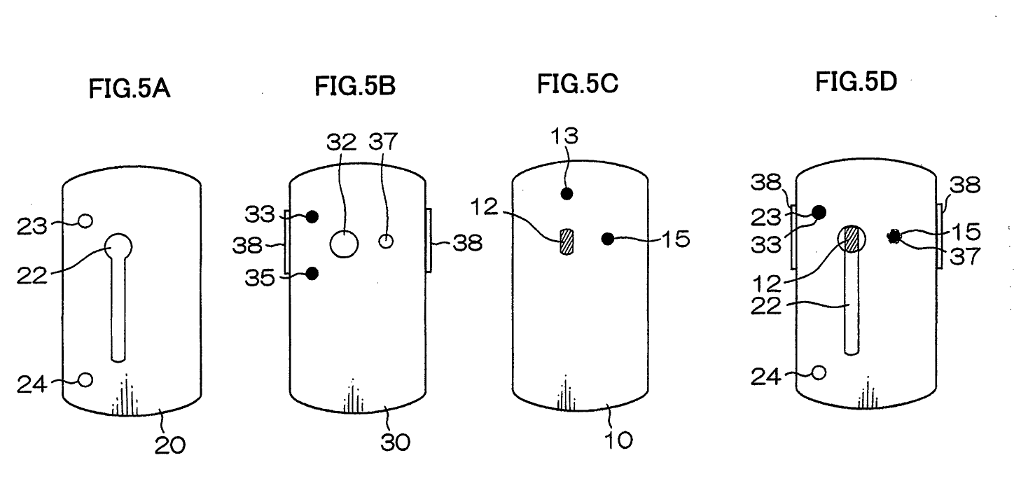

Next, the first position that is the stored state shown in FIG. 1A of the portable device 1 will be described by using FIGS. 5A to 5D. FIGS. 5A to 5D are views of the respective enclosures of the portable device 1 seen from the top surface.

FIG. 5A shows the state of the second enclosure 20 seen from the top surface, and shows the keyhole-shaped slit 22, the first round hole 23 and the second round hole 24 are shown by omitting the display 21 and the like as in FIG. 4. The round hole 25 for a lens is omitted here. FIG. 5B shows the state of the third enclosure 30 seen from the top surface, and shows the round hole 32 for rotation, the third lock pin 33, the fourth lock pin 35, the third round hole 37, and the restriction plates 38. FIG. 5C shows the state of the first enclosure 10 seen from the top surface, and shows the key 12, the first lock pin 13 and the second lock pin 15. The slipping-off prevention cap 17 fitted and fixed to the key 12 is omitted here.

FIG. 5D is a view of the first position that is the state in which the third enclosure 30 is overlaid on the first enclosure 10, and the second enclosure 20 is further overlaid on the third enclosure 30, that is, the stored state seen from the top surface. The second lock pin 15 and the third round hole 37 should be originally hidden behind the second enclosure 20 and invisible but are shown through the second enclosure 20 for convenience.

When the third enclosure 30 is overlaid on the first enclosure 10, the key 12 provided on the first enclosure penetrates through the round hole 32 for rotation provided on the third enclosure, and at the same time, the second lock pin 15 provided on the first enclosure is fitted in the third round hole 37 provided in the third enclosure. When the second enclosure 20 is further overlaid on the third enclosure 30, the key 12 which penetrates through the round hole 32 for rotation penetrates through the round hole portion of the keyhole-shaped slit 22 provided in the second enclosure, and at the same time, the third lock pin 33 provided in the third enclosure is fitted in the first round hole 23 provided in the second enclosure. Further, the slipping-off prevention cap 17 not shown here is fitted and fixed to the key 12.

As above, in the first position that is the stored state, the first enclosure 10 and the second enclosure 20 are integrated to sandwich the third enclosure 30, and this position can be maintained by fitting of the lock pin and the round hole.

In this state, the first lock pin 13 provided in the first enclosure 10 is pressed by the bottom surface portion of the third enclosure 30, and therefore, the first detection switch 16 provided at the lower portion of the first lock pin 13 is in an ON state. Similarly, the fourth lock pin 35 provided in the third enclosure 30 is pressed by the bottom surface portion of the second enclosure 20, and therefore, the second detection switch 36 provided at the lower portion of the fourth lock pin 35 is also in an ON state.

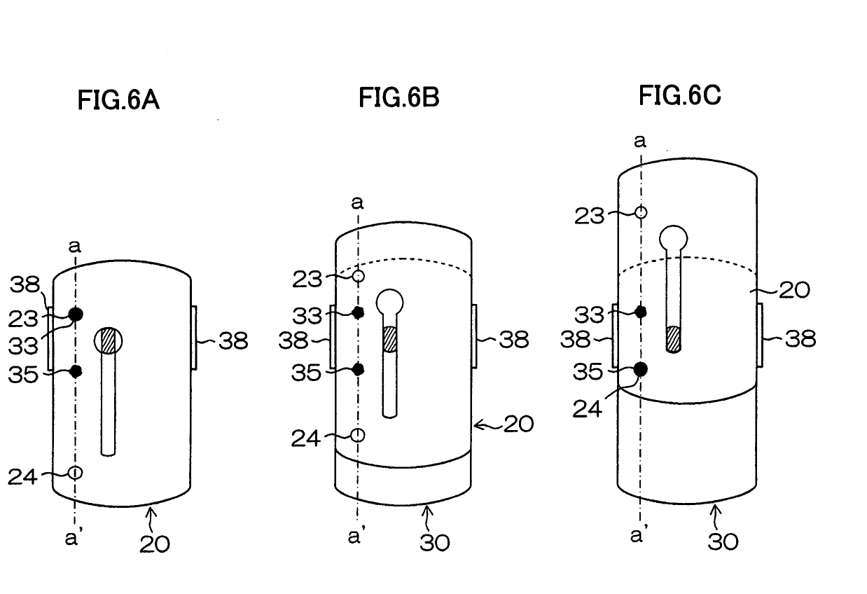

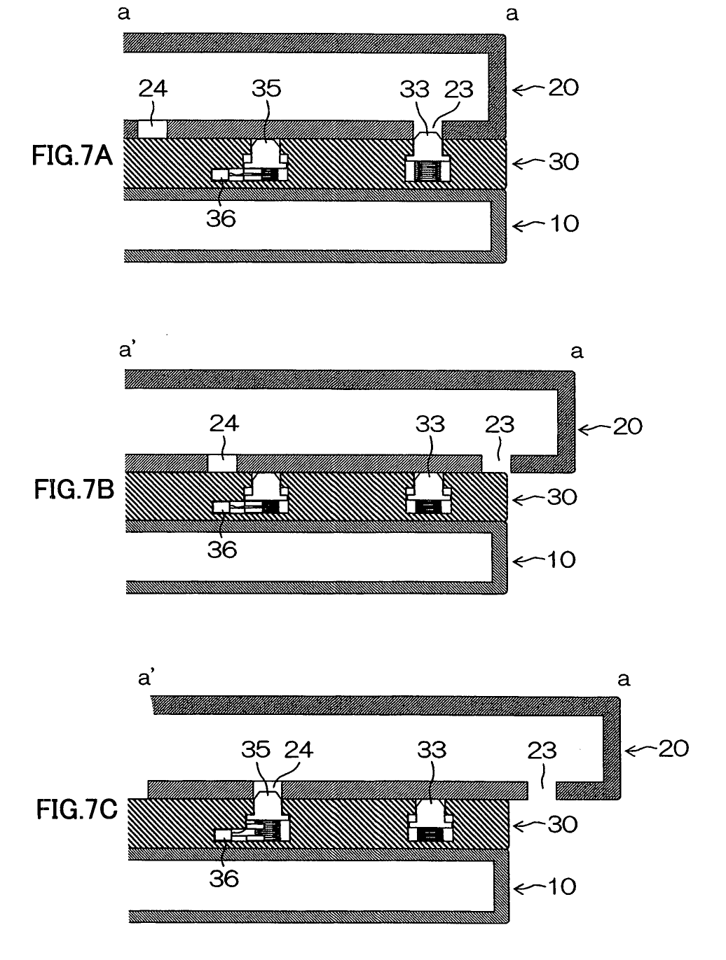

Next, a shift to the second position in which the display device is used in the vertical orientation shown in FIG. 1B from the first position which is the stored state of the portable device 1 will be described by using FIGS. 6A to 6C and 7A to 7C.

FIGS. 6A to 6C are views of transition of slide movement of the portable device 1 to the second position from the first position seen from the top surface. Concerning the second enclosure 20, a bottom surface is in a visible state by omitting the display 21 and the like, and the slipping-off prevention cap 17 is also omitted. FIGS. 7A to 7C are sectional views along the lines a to a′ in FIGS. 6A to 6C.

FIG. 6A is a top view of the first position, and FIG. 7A is a sectional view taken in the line a to a′ in FIG. 6A. The fourth lock pin 35 provided in the third enclosure 30 is invisible from the top surface, but is shown through the top surface for convenience. Since the fourth lock pin 35 is pressed by the back surface of the second enclosure 20 as shown in FIG. 7A, the second detection switch 36 is turned ON, and the third lock pin 33 is fitted in the first round hole 23.

FIG. 6B shows the state in which the second enclosure 20 is slid to move to the upper portion in the drawing from the state of FIG. 6A, and FIG. 7B is a sectional view taken in the line a to a′ of FIG. 6B. In this state, fitting of the first round hole 23 and the third lock pin 33 is released, and the second enclosure 20 slides to move to the upper portion in such a manner as to be guided by the restriction plates 38 provided in the third enclosure. The third lock pin 33 cannot be seen from the top surface, but is shown through the top surface for convenience here.

Here, the third enclosure 30 is provided with only the round hole 32 for rotation, and does not have a long hole portion like the keyhole-shaped slit 22 of the second enclosure 20, and therefore, cannot slide to move to the upper portion as the second enclosure 20. Therefore, the third enclosure 30 maintains the state integrated with the first enclosure 10 by fitting of the second lock pin 15 and the third round hole 37, and only the second enclosure 20 can slide to move in the upper direction.

FIG. 7C shows a view showing that the second enclosure 20 is further slid to move to the upper portion in the drawing from the state of FIG. 7B, and is in the second position which is the state in which the display portion is used in the vertical orientation, and FIG. 7C is a sectional view in the line a to a′ in FIG. 6C.

In this state, the key 12 is butted against the terminal end of the long hole portion of the keyhole-shaped slit 22, and further sliding movement from it is restrained, and at the same time, the second round hole 24 provided in the second enclosure and the fourth lock pin 35 provided in the third enclosure are fitted to be able to maintain this position. Specifically, in the state in which the display 21 provided on the second enclosure 20 is slid to move to the upper portion, the second operation part 31 provided on the third enclosure 30 is exposed, and the second operation part 31 can be used in the state in which the display 21 is seen in the vertical direction. In this state, the fourth lock pin 35 is fitted in the second round hole 24, and therefore, the second detection switch 36 provided at the lower portion of the fourth lock pin 35 is in the OFF state. The positional relationship of the first enclosure 10 and the third enclosure 30 does not change, and therefore, the first detection switch 16 not shown remains in the ON state.

The second enclosure 20 can be easily returned to the first position from the second position by sliding and moving the second enclosure 20 to the lower portion in the drawing.

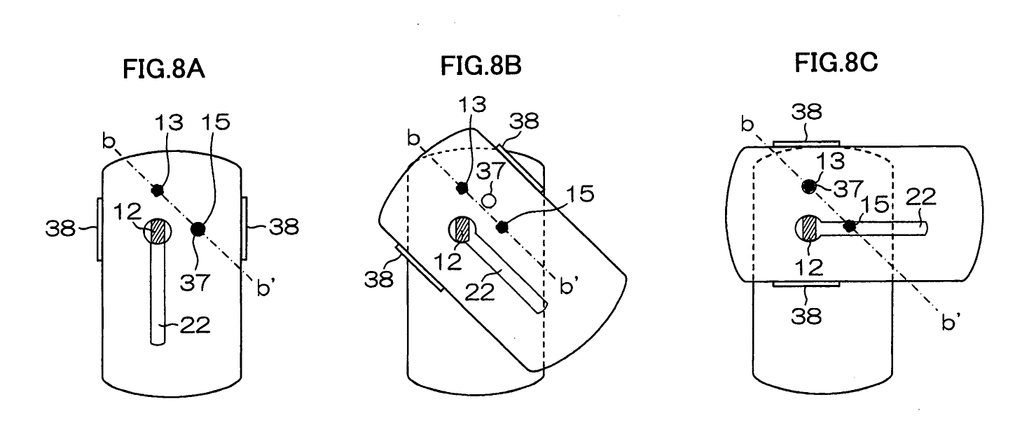

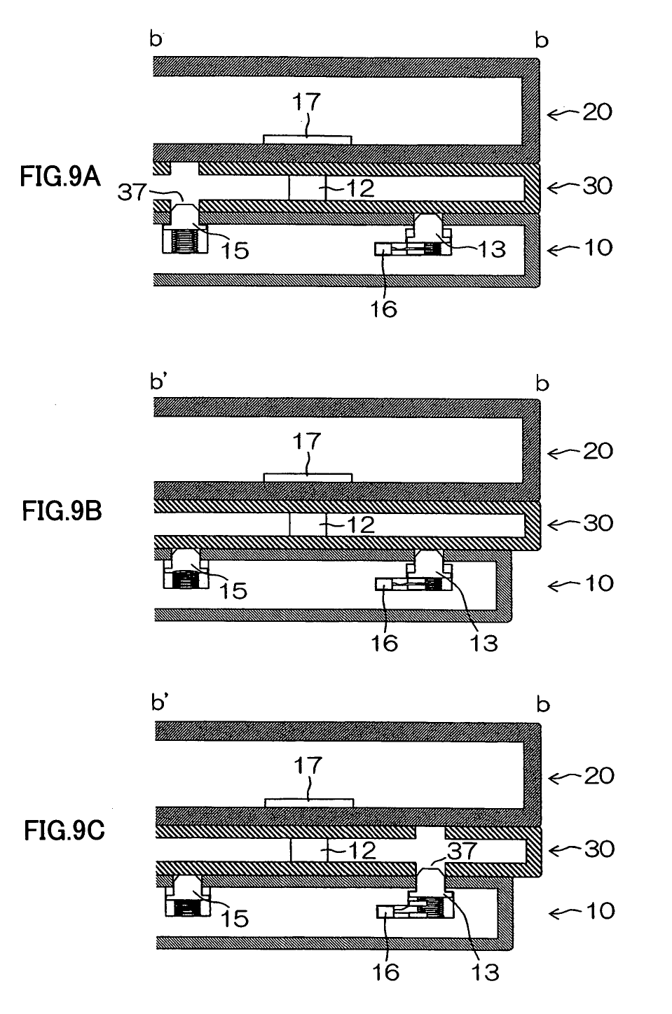

Next, a shift to the third position in which the display device is used in the horizontal orientation shown in FIG. 1C from the first position that is the stored state of the portable device 1 will be described by using FIGS. 8A to 8C and 9A to 9C.

FIGS. 8A to 8C are views of the transition of the rotational movement of the portable device 1 to the third position from the first position seen from the top surface. As for the second enclosure 20, the bottom surface is in a visible state by omitting the display 21 and the like, and the slipping-off prevention cap 17 is omitted. FIGS. 9A to 9C are sectional views in the lines b to b′ in FIGS. 8A to 8C.

FIG. 8A is a top view of the first position, FIG. 9A is a sectional view in the line b to b′ in FIG. 8A. The first lock pin 13 provided in the first enclosure 10 cannot be seen from the top surface, but it is shown through the top surface for convenience.

As described above, in the first position, the first round hole 23 and the third lock pin 33 are fitted to each other, and similarly, the third round hole 37 and the second lock pin 15 are fitted to each other.

FIG. 8B is a view showing the state in which the third enclosure 30 is rotated counterclockwise from the state of FIG. 8A, and FIG. 9B is a sectional view in the line b to b′ of FIG. 8B. In this state, fitting of the third round hole 37 and the second lock pin 15 is released, and the third enclosure 30 rotationally moves around the round hole 32 for rotation through which the key 12 penetrates. In this case, the restriction plates 38 are provided on both sides of the third enclosure 30, and therefore, when the third enclosure 30 is rotationally moved, the second enclosure 20 also rotationally moves integrally with the third enclosure.

FIG. 8C is a view showing that the third enclosure 30 is further rotated counterclockwise from the state of FIG. 8B, and is in the third position in which the display device is used in the horizontal orientation, and FIG. 8C is a sectional view in the line b to b′ in FIG. 9C. In this state, the third round hole 37 provided in the third enclosure 30 is fitted to the first lock pin 13 provided in the first enclosure 10 to be able to maintain this position. Specifically, the first operation part 11 provided in the first enclosure 10 is exposed in the state in which the display 21 provided in the second enclosure 20 is rotationally moved to the upper portion, and the first operation part 11 can be used with the display 21 seen in the horizontal direction.

In this state, the first lock pin 13 is fitted in the third round hole 37, and therefore, the first detection switch 16 provided at the lower portion of the first lock pin 13 is in the OFF state. Since the positional relationship of the third enclosure 30 and the second enclosure 20 does not change, the second detection switch 36 not shown remains in the ON state. Counterclockwise rotation of the third enclosure 30 is restricted to the 90 degrees by a stopper not shown, and therefore, the third enclosure 30 does not rotate more than 90 degrees.

Further, the portable device can be easily returned to the first position from the third position by rotationally moving the third enclosure 30 clockwise. At this time, the second enclosure 20 rotates integrally with the third enclosure 30 by the restriction plates 38.

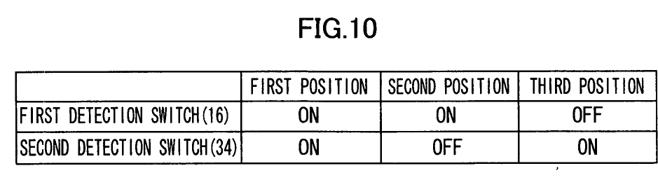

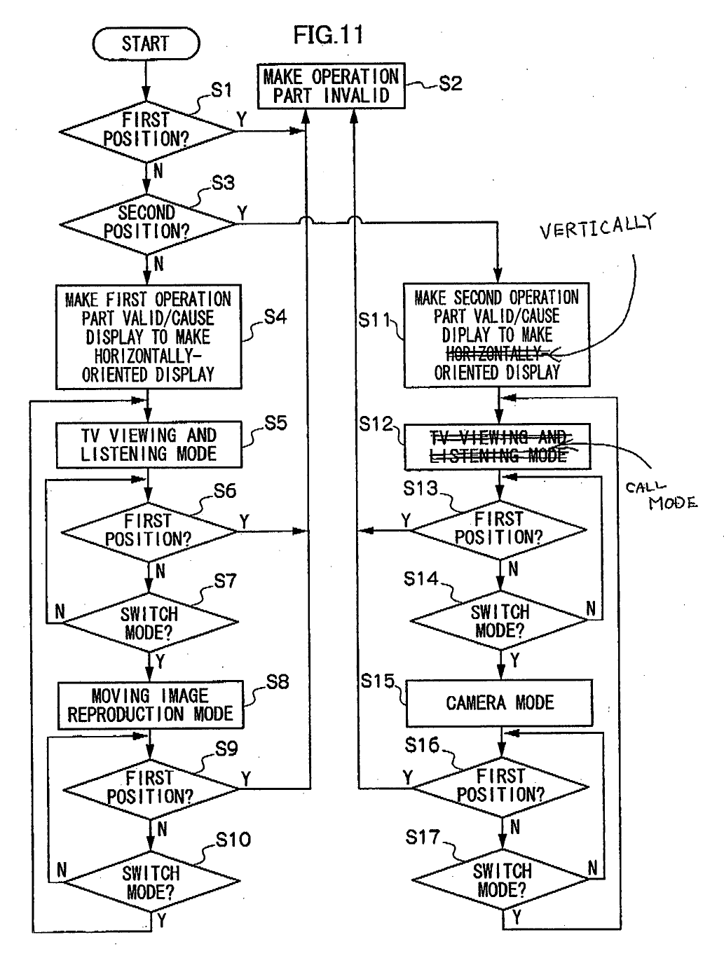

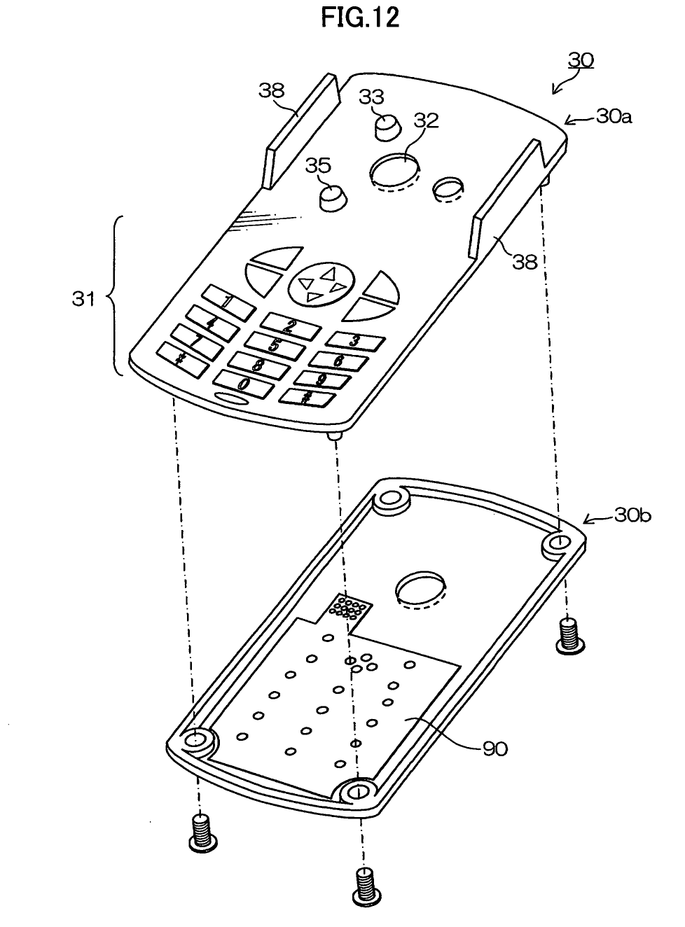

Next, an operation of the portable device 1 will be described by using FIGS. 10 and 11. FIG. 10 is a table showing an ON/OFF state of the first detection switch 16 and the second detection switch 34 at each position, and as described above, the combination of ON and OFF differs in accordance with each position. FIG. 11 is a flowchart showing an operation state of the portable device 1.

First, the system control part 109 determines which state the portable device 1 is in based on ON/OFF information of the first detection switch 16 and the second detection switch 34. First, the system control part 109 determines whether the portable device 1 is in the first position or not (step S1). When it determines that the portable device is in the first position, it makes inputs of the first operation part 11 and the second operation part 31 invalid and brings the display 21 into a non-display state at the same time (step S2), and reduces power consumption. The system control part 109 maintains the state until it determines that the position is shifted to another position. In the first position, the portable device is in a call waiting mode, and arrival of a telephone call and reception of an electronic mail are possible by the system control part 109 operating the telephone control part 102. Thereafter, in any mode, arrival of a telephone call and reception of an electronic mail are possible.

When the system control part 109 determines that the portable device is not in the first position, it determines whether the portable device is in the second position or in the third position next (step S3). When it determines that the portable device is in the third position here, it makes the first operation part 11 valid, and causes the display 21 to display horizontally (step S4).

Next, the system control part 109 sets the portable device 1 in a television viewing and listening mode (step S5), and causes the television control part 106 to operate to make television viewing and listening possible. Since at this time the first operation part 11 suitable for television viewing and listening is exposed and the operation is valid, channel switching, volume adjustment and the like are possible by using the first operation part 11.

The system control part always monitors the first detection switch 16 and the second detection switch 34 (step S6), and when it determines that the position shifts to the first position, it makes the first operation part 11 invalid and stops display on the display (step S2).

In this state, it is possible to shift the portable device to a moving image reproduction mode from a television viewing and listening mode by using the first operation part 11 (step S7). The mode switching may be performed by inserting external media into the storage part 107. When the mode switching is performed, the system control part 109 sets the portable device 1 in the moving image reproduction mode (step S8), stops the television control part 106 and operates the moving image reproduction control part 108 to enable moving image reproduction. At this time, the first operation part 11 suitable for moving image reproduction is exposed as in the television viewing and listening mode, and the input is made valid. Therefore, start, stop and temporary stop of reproduction, volume adjustment and the like are possible by using the first operation part 11.

As in the television viewing and listening mode, the system control part always monitors the first detection switch 16 and the second detection switch 34 (step S9), and when it determines that the portable device shifts to the first position, it makes the first operation part 11 invalid, and stops the display on the display (step S2).

It is possible to shift the portable device to the television viewing and listening mode from the moving image reproduction mode (step S10), and when mode switching is performed, the system control part 109 sets the portable device 1 in the television viewing and listening mode (step S5), and stops the moving image reproduction control part 108 and operates the television control part 106 to enable television viewing and listening.

When the system control part 109 determines that the portable device is in the second position in step S3, it makes the second operation part 31 valid and allows the display 21 to display in the vertical orientation (step S11). Next, the system control part 109 sets the portable device 1 in the call mode (step S12), and controls the telephone control part 102, whereby a call to an optional number, transmission of an electronic mail, address book search and the like are enabled in addition to arrival of a telephone call and reception of an electronic mail which are possible in all the modes. Since at this time, the second operation part 31 suitable for the telephone function is exposed, and the input is valid, favorable usability is obtained.

The system control part always monitors the first detection switch 16 and the second detection switch 34 (step S13), and when the system control part determines that the portable device shifts to the first position, it makes input of the second operation part 31 invalid, and brings the display 21 into a non-display state (step S2).

It is possible to shift the portable device to a camera mode from the call mode by using the second operation part 31 (step S15). When mode switching is performed, the system control part 109 sets the portable device 1 in the camera mode (step S15), controls the telephone control part 102 to limit the telephone function only to arrival of a telephone call and reception of an electronic mail, and operates the camera control part 103 to enable image-taking. At this time, the second operation part 31 suitable for image-taking is exposed as in the call mode, and the input is valid. Therefore, image-taking mode switching, zoom adjustment and actual image-taking are possible by using the second operation part 31.

The system control part 109 always monitors the first detection switch 16 and the second detection switch 34 as in the call mode (step S16). When the system control part 109 determines that the portable device shifts to the first position, it makes the second operation part 31 invalid and brings the display 21 into a non-display state (step S2).

Further, it is possible to shift the portable device to the call mode from the camera mode (step S17), and when mode switching is performed, the system control part 109 sets the portable device 1 in the call mode (step S12), and stops the camera control part 103 and controls the telephone control part 102 to enable a call and electronic mail transmission.

Next, the third enclosure 30 will be described by using FIG. 12. FIG. 12 is an exploded perspective view of the third enclosure 30. The third enclosure 30 includes a top surface part 30a including the second operation part 31, the third lock pin 33, the fourth lock pin 35 and the restriction plates 38, a membrane switch 90 and a lower surface part 30b, and is configured so that the top surface part 30a and the lower surface part 30b sandwich the membrane switch 90.

The membrane switch 90 connects to the main board 110 of the first enclosure 10 by using a flexible printed board not shown as the signals of the second detection switch 36 and the microphone 39. By adopting such a configuration, the button arrangement of the first operation part 11 and the button arrangement of the second operation part 31 can be freely set, and the button arrangement suitable for each function can be made.

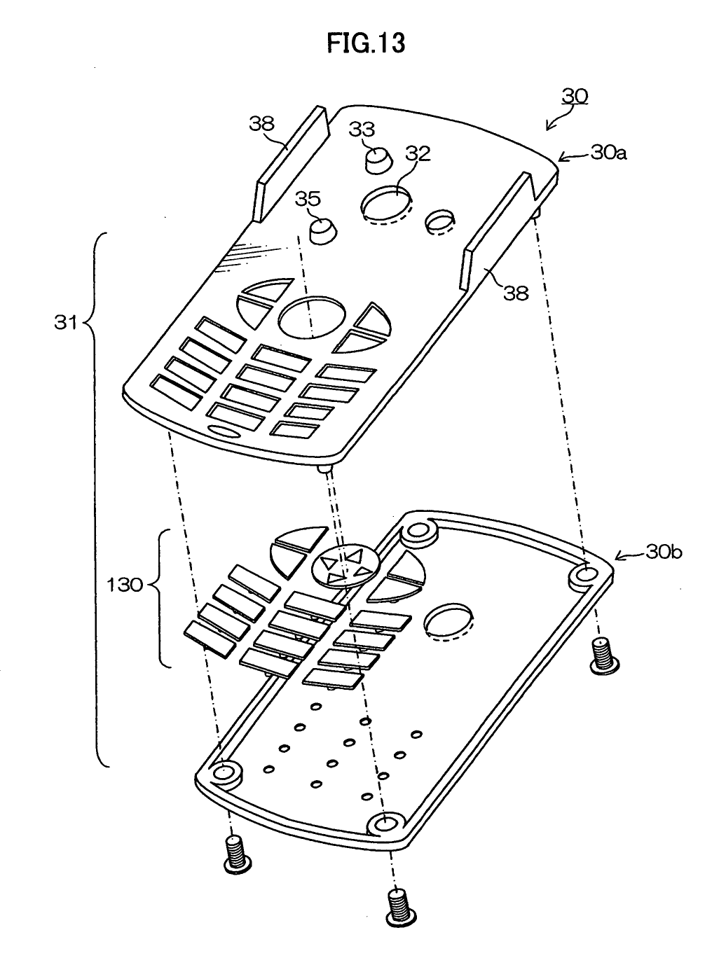

The third enclosure 30 is not limited to the embodiment, and may be configured as shown in FIG. 13. The third enclosure 30 shown in FIG. 13 includes only key tops of the operation buttons, and when the key top is pressed, the key shaft projects from a hole portion for a key shaft provided in the bottom surface portion of the third enclosure 30.

FIG. 13 is an exploded perspective view of the third enclosure 30. The third enclosure 30 includes the top surface part 30a including the third lock pin 33, the fourth lock pin 35 and the restriction plates 38, the lower surface part 30b including the hole portions for key shafts, and a key top group 130, and is configured so that the top surface part 30a and the lower surface part 30b sandwich the key top group 130.

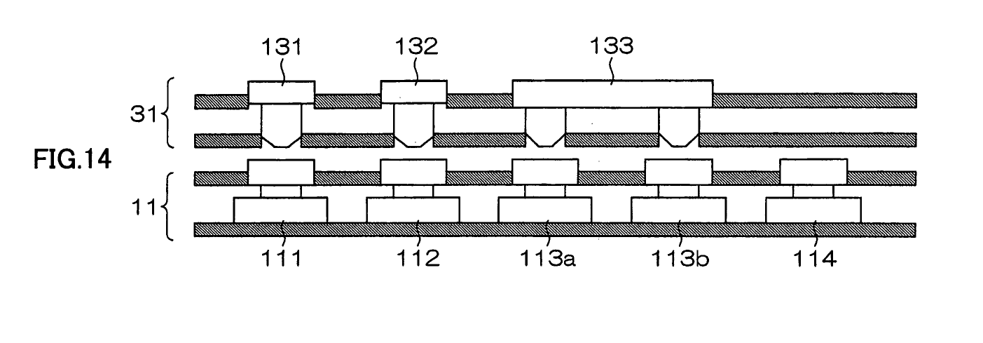

FIG. 14 is a sectional view of the second operation part 31 of the third enclosure and the first operation part 11 of the first enclosure 10 in the second position. As described above, in the second position, only the second enclosure 20 slides to move, the third enclosure 30 and the first enclosure 10 are integrated, and the second operation part 31 of the third enclosure 30 is exposed by the second enclosure 20 sliding to move. At this time, the positional relationship of the operation buttons of the second operation part 31 and the first operation part 11 has the configuration as shown in FIG. 14. Specifically, the first key top 131 of the second operation part 31 is disposed directly above a first operation button 111 of the first operation part 11, and the second key top 132 of the second operation part 31 is disposed directly above a second operation button 112 of the first operation part 11.

By disposing them as above, by a user pressing the first key top 131, the key shaft of the first key top 131 presses the first operation button 111 through the hole portion for the key shaft, and by the user pressing the second key top 132, the operation of the key shaft of the second key top 132 pressing the second operation button 112 through the round hole for the key shaft becomes possible.

The system control part 109 can determine which position of the second position and the third position the portable device is in by the ON/OFF state of the position detection switch in advance as shown in FIG. 9, and therefore, it can distinguish whether the input of the first operation button 111 is the input made by directly pressing the first operation button 111 or the input made by pressing the first operation button 111 made by pressing the first key top 131.

As shown in FIG. 13, if all the key tops of the second operation part 31 are configured as above, the structure is simplified, exchange of signals of the flexible printed boards of the third enclosure 30 and the first enclosure 10 can be reduced, and cost can be reduced.

As shown in FIG. 14, it is possible to dispose a third key top 133 including two key shafts and hole portions for key shafts with one operation button directly above a third operation button 113a and a fourth operation button 113b of the first operation part 11. By adopting such a configuration, the key shaft of the third key top 133 presses the third operation button 113a through the round hole for the key shaft when the left side of the third key top 133 is pressed, the key shaft of the third key top 133 presses the fourth operation button 113b through the round hole for the key shaft when the right side of the third key top 133 is pressed, and the key shafts of the third key top 133 press both the third operation button 113a and the fourth operation button 113b through the round holes for the key shafts when the center of the third key top 133 is pressed, and they can be assigned to different functions respectively.

As shown in FIG. 14, it is possible not to dispose a key top of the second operation part 31 directly above the fifth operation button 114 of the first operation part 11.

As above, according to the present invention, the portable device can be brought into the use state from the stored state by one action, the orientation of the display can be changed in correspondence with the use purpose, and the operation part corresponding to the use purpose can be used. Therefore, portable device with high usability can be realized.

### Second Embodiment

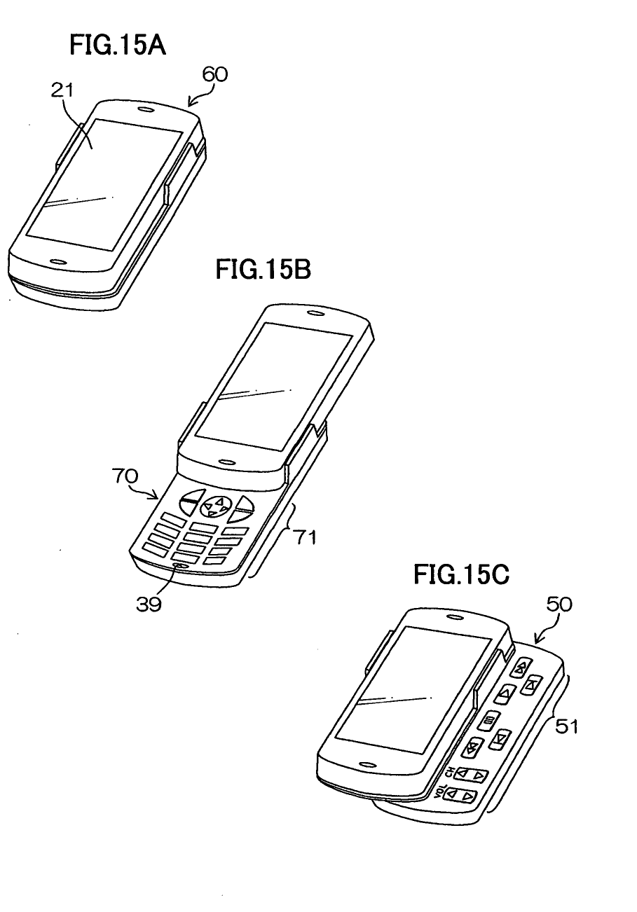

The portable device 1 of a second embodiment according to the present invention will be described by using FIGS. 15 to 20. The same reference numerals are given to the parts common to the first embodiment, and the detailed description of them will be omitted.

FIGS. 15A to 15C are perspective views of the portable device 1 of the second embodiment according to the present invention seen from the front. FIG. 15A shows the first position that is the stored state. FIG. 15B shows the second position that is a state of using the display device in a vertical orientation. FIG. 15C shows the third position that is a state of using the display device in a horizontal orientation. In a second operation part 71 shown in FIG. 15B, operation buttons for the telephone and camera are placed, and in a first operation part 51 shown in FIG. 15C, operation buttons for TV viewing and listening and moving image reproduction are placed.

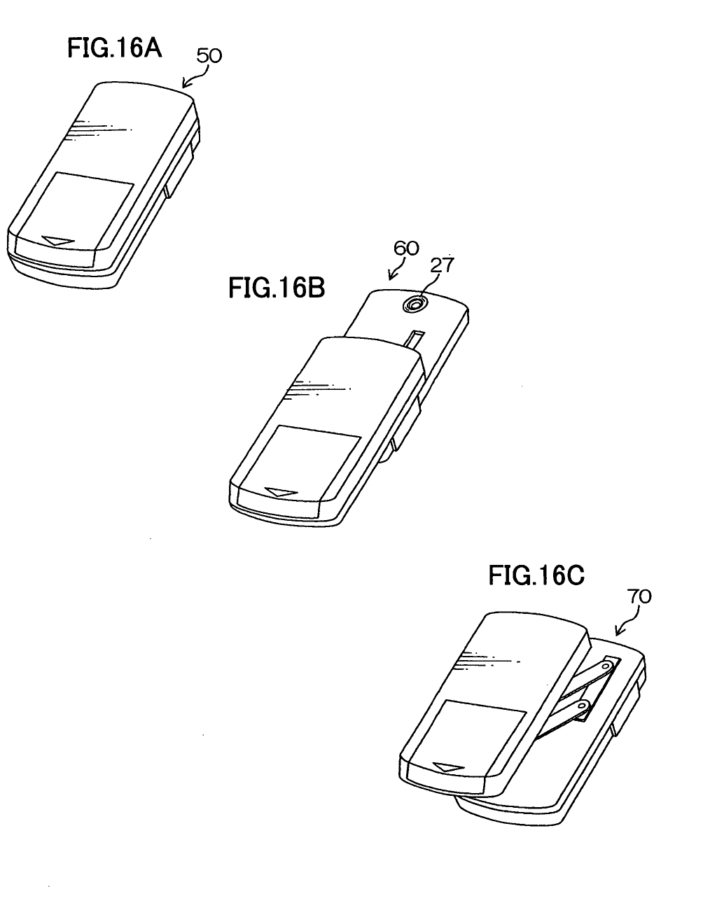

FIGS. 16A to 16C are perspective views of the portable device 1 seen from the rear side. FIG. 16A shows the first position. FIG. 16B shows the second position. FIG. 16C shows the third position. As shown in FIG. 16B, an image-taking lens 27 is placed on a rear surface portion of a second enclosure 60.

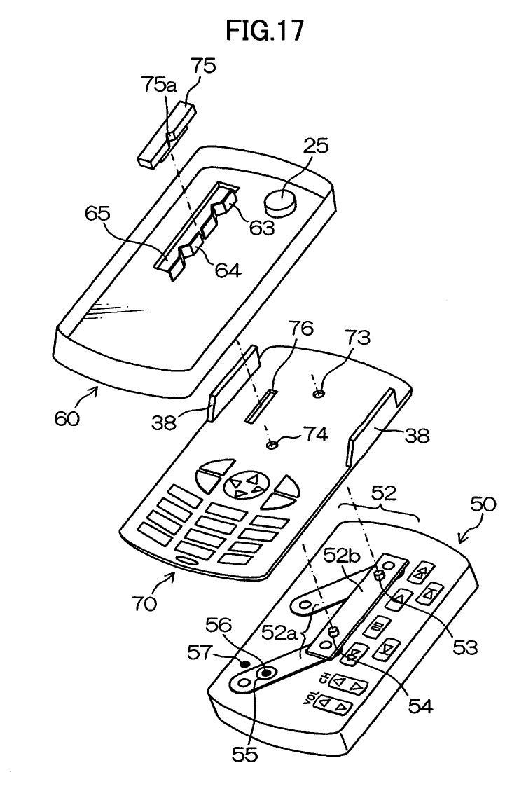

Next, a joint mechanism (link mechanism) of the portable device 1 of the second embodiment according to the present invention will be described by using FIG. 17. FIG. 17 is an exploded perspective view of the portable device 1, and the second enclosure 60 is illustrated so that a bottom surface is seen from a top portion by omitting a display 21 and the like as in the description of the first embodiment.

Reference numeral 52 denotes a parallel-linking mechanism constituted of a link arm 52a and a plate 52b, and reference numerals 53 and 54 denote a first projection portion and a second projection portion provided on a plate 52b. A fifth lock pin 56 and a sixth lock pin 57 are placed on the first enclosure 50, in addition to a fifth round hole 55 provided in the link arm 52a.

A first lock spring 63, a second lock spring 64 and a rail groove 65 are placed on the second enclosure 60. A first round hole 73 and a second round hole 74 are placed in a third enclosure 70, and are respectively fitted to the first projection portion 53 and the second projection portion 54 provided on the plate 52b, and thereby, the first enclosure 50 and the third enclosure 70 are integrated. A rail 75 is fitted in a rail joining groove 76 to sandwich the second enclosure 60, and thereby, the second enclosure 60 and the third enclosure 70 are integrated. As above, the portable device 1 of the second embodiment according to the present invention has the constitution in which the first enclosure 50, the second enclosure 60 and the third enclosure 70 are integrated.

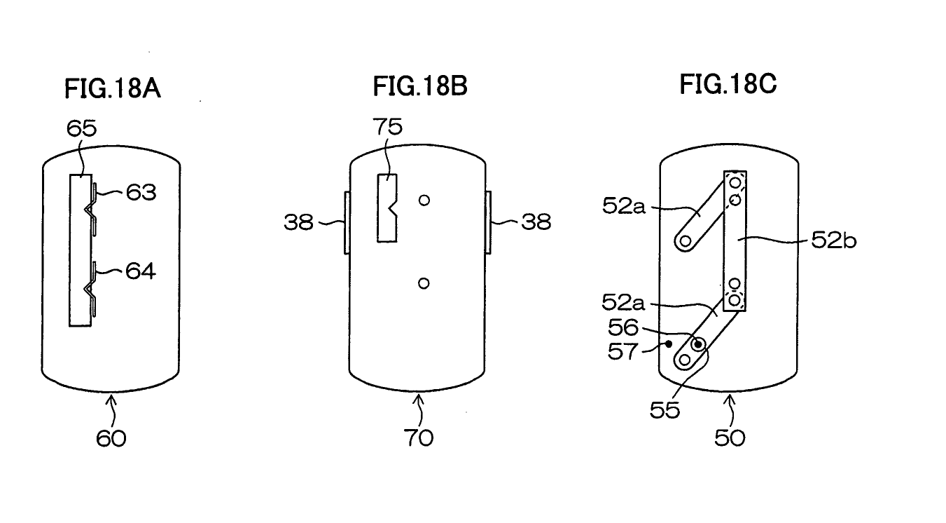

FIGS. 18A, 18B and 18C are views of the respective enclosures seen from top portions. FIG. 18A is a view of the second enclosure 60 seen from the top portion, and shows the first lock spring 63, the second lock spring 64 and the rail groove 65, but omits the round hole 25 for a lens. FIG. 18B is a view of the third enclosure 70 seen from the top portion, and shows the restriction plates 38 and the rail 75. FIG. 18C is a view of the first enclosure 50 seen from the top portion, and shows the fifth round hole 55 provided in the link arm, the fifth lock pin 56 and the sixth lock pin 57 provided on the first enclosure 50, in addition to the parallel-linking mechanism 52, with the fifth hole 55 for lock and the fifth lock pin 56 fitted to each other.

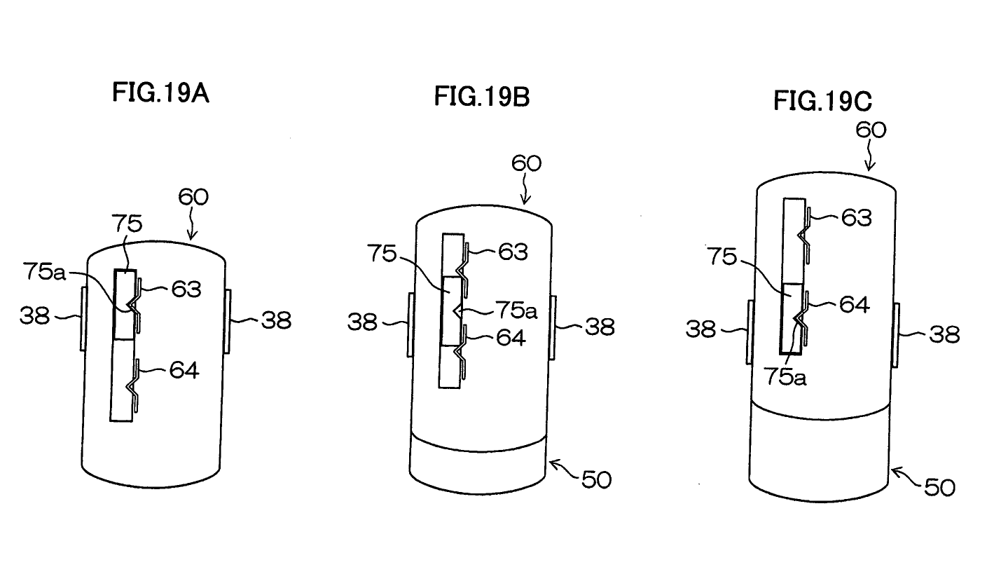

FIGS. 19A to 19D are views of transition of vertical slide movement of the portable device 1 from the first position that is a stored state to the second position that is a state of using the display device in a vertical orientation seen from the top side, and as for the second enclosure 60, the bottom surface is visible from the top portion by omitting the display 21 and the like.

FIG. 19A is a view of the state of the first position seen from the top side, and the first lock spring 63 provided in the second enclosure 60 engages with a V groove (see FIG. 17) formed at a side portion of the rails 75 joined to the third enclosure 70.

FIG. 19B is a view showing a state in which the second enclosure 60 is slid to move to the upper portion of the drawing from the state of FIG. 19A. In this state, engagement of the first lock spring 63 and the V groove of the rail 75 is released, and the second enclosure 60 slides to move straight to the upper portion by being guided by the restriction plates 38 at both sides of the third enclosure 70. Here, the third enclosure 70 is joined to the first enclosure 50 by the parallel-linking mechanism 52, and cannot slide and move to the upper portion together with the second enclosure 60. Therefore, the third enclosure 70 remains to be integrated with the first enclosure 50, and only the second enclosure 60 can slide and move.

FIG. 19C is a view showing that the second enclosure 60 is further slid and moved to the upper portion of the drawing from the state of FIG. 19B, and the portable device is in the second position that is the state of using the display device in the vertical orientation. In this state, the rail 75 butts against a terminal end of the rail groove 65 to restrict further slide movement from it, and at the same time, the second lock spring 64 and the V groove of the rail 75 are engaged with each other, and can maintain this position. At this time, the position detecting mechanism not shown detects that the portable device is in the second position, and the system control part 109 makes the display of the display 21 in a vertical direction to make the second operation part 71 usable.

Specifically, the second operation part 71 provided in the third enclosure 70 is exposed in the state in which the display 21 provided in the second enclosure 20 is slid and moved to the upper portion, and the second operation part 71 can be used with the display 21 seen in the vertical direction. Here, in the second position, the telephone function and camera function are usable, and as described above, the second operation part 71 becomes the operation part for a telephone and a camera as described above.

The portable device can be easily returned to the first position from the second position by sliding and moving the second enclosure 60 to the lower portion of the drawing. At this time, the rail 75 is released from the engagement with the second lock spring 64, and engages with the first lock spring 63 to return to the first position. By a position detecting mechanism not shown, it is detected that the portable device is in the first position, the input of the second operation 71 is made invalid, and the display 21 is brought into a non-display state.

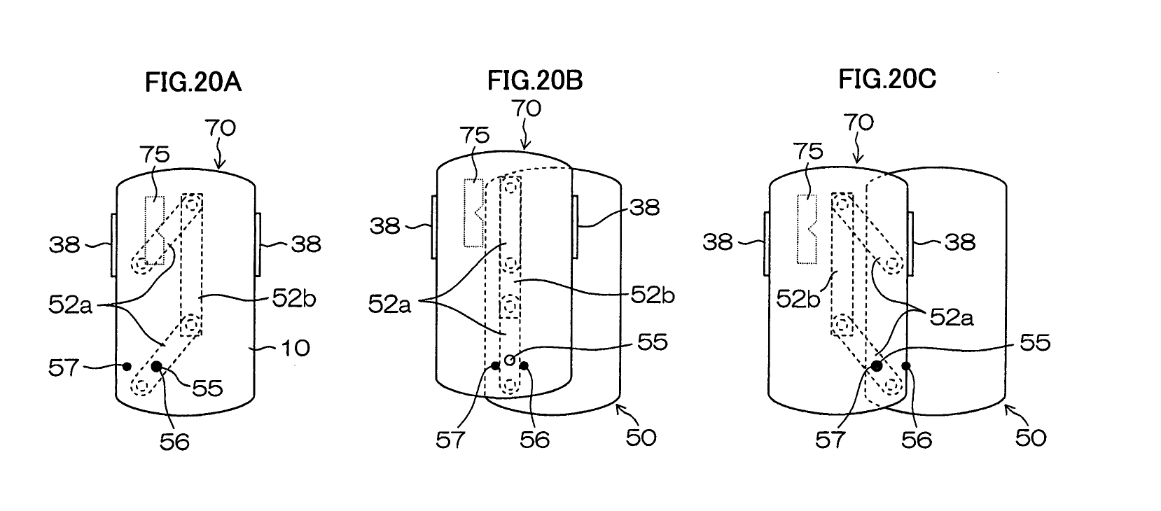

Next, a shift to the third position that is the state of using the display device in the horizontal orientation from the first position that is the stored state will be described by using FIGS. 20A to 20C. FIGS. 20A to 20C are views of the transition of the horizontal slide movement of the portable device 1 from the first position to the third position seen from the top side, and the second enclosure 60 is omitted.

FIG. 20A is a view of the state of the first position seen from the top side. The parallel-linking mechanism and the lock spring included in the first enclosure 50 are not originally seen from the top side, but are shown through the top for convenience. In the first position, the fifth round hole 55 provided in the link arm 52a and the fifth lock pin 56 provided in the first enclosure are fitted to each other, and the state in which the first enclosure and the third enclosure are integrated is maintained.

FIG. 20B is a view showing the state in which the third enclosure 70 is slid and moved in the left direction from the state of FIG. 20A. In this state, fitting of the fifth round hole 55 and the fifth lock pin 56 is released, and the third enclosure 70 moves along the circular arc drawn by the link arm. As for the second enclosure 60 and the third enclosure 70, the second enclosure 60 slides and moves while remaining to be integrated with the third enclosure 70 by engagement of the rail 75 and the first lock spring 63 and the restriction plates 38.

FIG. 20C is a view showing that the third enclosure 70 is further moved to the left from the state of FIG. 20B, and is in the third position that is the state of using the display device in the horizontal orientation. In this state, the fifth round hole 55 and the sixth lock pin 57 are fitted to each other, and the position can be maintained. Movement of the third enclosure 70 is restricted to the third position by the stopper not shown, and therefore, the third enclosure 70 does not move to the left side from the third position.

At this time, the system control part 109 detects that the portable device is in the third position by the position detecting mechanism not shown, and the system control part 109 makes the display of the display 21 in the horizontal orientation, and makes the first operation part 51 usable.

Specifically, the first operation part 51 provided in the first enclosure 50 is exposed in the state in which the display 21 provided in the second enclosure 60 is slid and moved to the left portion, and by tilting the entire device at 90 degrees, the first operation part 51 can be used in the state in which the display 21 is seen in the horizontal direction. In the third position, the TV viewing and listening function and the moving image reproducing function are usable. As described above, the first operation part 51 is the operation part for TV viewing and listening and moving image reproduction.

In order to return the portable device to the first position from the third position here, the second enclosure 60 and the third enclosure 70 are moved to the right side while they are kept to be integrated. The fifth round hole 55 releases from fitting with the sixth lock pin 57, and is fitted to the fifth lock pin 56. At this time, the system control part detects that the portable device is in the first position by the position detecting mechanism not shown, makes the first operation part 51 invalid, and brings the display 21 into a non-display state.

As shown in FIG. 16B, in the second position, the image-taking lens 27 is exposed, and by pointing the lens to a subject, and operating the button for camera operation, image-taking is possible. On the other hand, as shown in FIGS. 16A and 16C, the image-taking lens 27 is not exposed in the first position and the third position, and therefore, the image-taking lens can be protected when the lens is not used.

In this embodiment, the slit mechanism is used for slide movement to the second position from the first position, and the parallel-linking mechanism is used for slide movement to the third position from the first position. However, the parallel-linking mechanism may be used for slide movement to the second position from the first position, and the slit mechanism may be used for slide movement to the third position from the first position.

In this embodiment, the slide movement to the second position from the first position and the slide movement to the third position from the first position are not restricted respectively, and therefore, the slide movement of both of them can be performed at the same time, but in this case, the operation of the position which the position detecting mechanism first detects is performed. Naturally, a restriction mechanism may be provided so as to perform only slide movement of any one of them.

In this embodiment, as shown in FIGS. 15A to 15C, the third enclosure 70 is integrated with the first enclosure 50 and fixed with the slide movement to the second position from the first position, and only the second operation part 71 provided on the third enclosure 70 is exposed in the second position. However, it goes without saying that by forming the first round hole 73 and the second round hole 74 which restrict the movement in the vertical direction of the third enclosure 70 to be long holes, for example, the third enclosure 70 may be constituted to move integrally with the first enclosure 50 partway to expose part of the first enclosure 50, as long as the different operation parts are operable respectively in the second position and the third position.

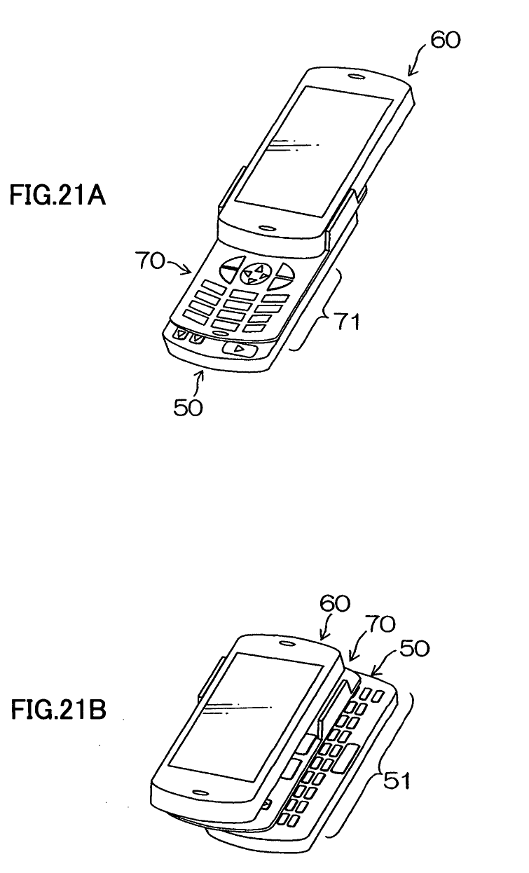

FIG. 21A is a view showing the second position that is the state in which part of the first enclosure 50 is exposed. An operation member may be provided on the exposed part of the first enclosure 50, and in this case, an operation member may be provided as long as the different operation parts are operable respectively in the second position and the third position.

As shown in FIGS. 15A to 15C, with the slide movement to the third position from the first position, the third enclosure 70 is integrated with the second enclosure 60 and fixed, and in the third position, only the first operation part 51 provided on the first enclosure 50 is exposed. However, it goes without saying that when with the method of giving the restriction plates 38 an allowance or the like, for example, the third enclosure 70 is completely integrated with the second enclosure 60 and does not move with the slide movement of the first enclosure 50 to the third position from the first position, part of it covers the surface of the first enclosure, and a part of the third enclosure 70 is exposed, the same operation can be obtained as long as the different operation parts are respectively operable in the second position and the third position.

FIG. 21B is a view showing the third position that is the state in which part of the third enclosure 70 covers the first enclosure 50 and part of the third enclosure 70 is exposed. An operation member may be also provided on the exposed part of the third enclosure as long as the different operation parts are operable in the second position and the third position in this case.

The second operation part 71 may be eliminated in the third enclosure 70, and in the second position in this case, the third enclosure 70 plays a role of covering the first operation part 51. The microphone 39 is exposed, the positional relationship of the speaker 26 and the microphone 39 is such that they are separated at a distance favorable for a call, and the speaker 26 and the microphone 39 are applied to an ear and a mouth respectively, whereby the constitution with favorable usability in the telephone function is provided.

Similarly, the first operation part 51 may be eliminated from the first enclosure 50, and in the third position in this case, by tilting the entire device at 90 degrees and by holding the first enclosure 50 by hand in the sate in which the display 21 is seen in the horizontal direction, the constitution easy to hold is provided.

### Third Embodiment

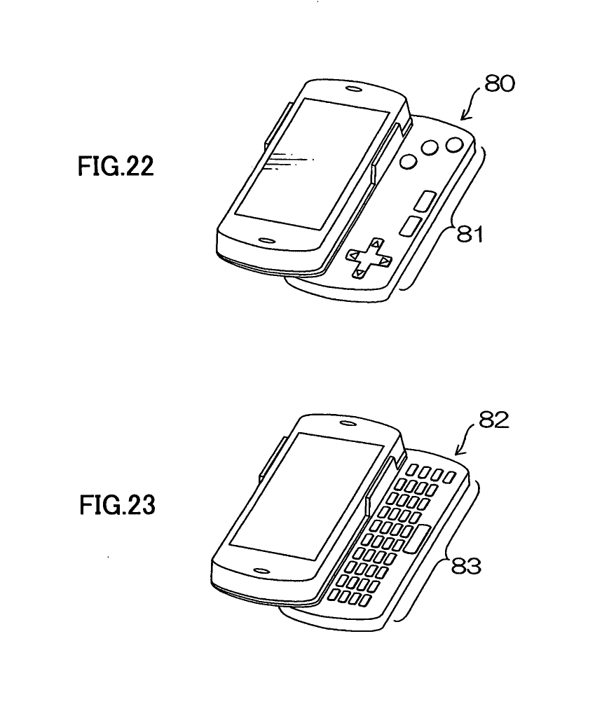

By using FIG. 22, the portable device 1 of the third embodiment according to the present invention will be described.

The portable device 1 of the third embodiment according to the present invention has the same constitution as in the second embodiment, but differs from the second embodiment in the point that in the third position which is the state of using the display in the horizontal orientation, a game function is usable, and a first operation part 81 provided in a first enclosure 80 is the operation part for game.

### Fourth Embodiment

By using FIG. 23, the portable device 1 of the fourth embodiment according to the present invention will be described.

The portable device 1 of the fourth embodiment according to the present invention has the same constitution as the second embodiment, but differs from the second embodiment in the point that in the third position which is the state of using the display in the horizontal orientation, a PDA function is usable, and a first operation part 83 provided in a first enclosure 82 is a full keyboard.

What is claimed is:

1. A portable device, comprising:
a first enclosure including a first operation part;
a second enclosure including a display part;
a third enclosure; and
a joint mechanism which joints the first enclosure, the second enclosure and the third enclosure respectively, and joints the second enclosure movably with respect to the first enclosure from a first position in which a silhouette of the second enclosure is overlaid on the first enclosure to a second position and a third position differing from each other,
wherein
in the first position, the joint mechanism integrally joints the second enclosure so as to be overlaid on silhouettes of the first enclosure and the third enclosure,
when the second enclosure moves to the second position from the first position, the joint mechanism causes the third enclosure to be exposed by restricting a moving amount of the third enclosure accompanying the movement of the second enclosure to zero or to be smaller than a moving amount of the second enclosure, and
when the second enclosure moves to the third position from the first position, the joint mechanism causes the first operation part to be exposed in an operable state by restricting the moving amount of the third enclosure accompanying the movement of the second enclosure to be the same as that of the second enclosure or to be smaller than the moving amount of the second enclosure.

2. The portable device according to claim 1,
wherein the joint mechanism is constituted so that
when the second enclosure moves to the second position from the first position with respect to the first enclosure, second enclosure moves parallel in a first direction, and
when the second enclosure moves to the third position from the first position with respect to the first enclosure, the second enclosure moves parallel in a second direction differing from the first direction.

3. The portable device according to claim 2,
wherein the joint mechanism uses a parallel-linking mechanism as a mechanism for the second enclosure to perform parallel movement in one direction of parallel movement in two directions that are the first direction and the second direction.

4. The portable device according to claim 1,
wherein the joint mechanism is constituted so that
when the second enclosure moves to the second position from the first position with respect to the first enclosure, the second enclosure performs parallel movement, and
when the second enclosure moves to the third position from the first position with respect to the first enclosure, the second enclosure performs rotational movement.

5. The portable device according to claim 4, further comprising a restriction mechanism restricting movement of the second enclosure,
wherein the restriction mechanism restricts the motion of the second enclosure so as to
allow parallel movement and rotational movement of the second enclosure in the first position,
allow only the parallel movement of the second enclosure in the second position, and
allow only the rotational movement of the second enclosure in the third position.

6. The portable device according to claim 1,
wherein the joint mechanism is constituted so that
when the second enclosure moves to the second position from the first position with respect to the first enclosure, the second enclosure performs rotational movement, and
when the second enclosure moves to the third position from the first position with respect to the first enclosure, the second enclosure performs parallel movement.

7. The portable device according to claim 6, further comprising a restriction mechanism restricting movement of the second enclosure,
wherein the restriction mechanism restricts motion of the second enclosure so as to
allow parallel movement and rotational movement of the second enclosure in the first position,
allow only rotational movement of the second enclosure in the second position, and
allow only parallel movement of the second enclosure in the third position.

8. The portable device according to claim 1, further comprising:
a stop mechanism stopping the second enclosure with predetermined holding forces respectively in the first position, the second position and the third position.

9. A portable device, comprising:
a first enclosure including a first operation part;
a second enclosure including a display part;
a third enclosure including a second operation part; and
a joint mechanism which joints the first enclosure, the second enclosure and the third enclosure respectively, and joints the second enclosure movably with respect to the first enclosure from a first position in which a silhouette of the second enclosure is overlaid on the first enclosure to a second position and a third position differing from each other,
wherein
in the first position, the joint mechanism integrally joints the second enclosure so as to be overlaid on silhouettes of the first enclosure and the third enclosure,
when the second enclosure moves to the second position from the first position, the joint mechanism causes the second operation part to be exposed in an operable state by restricting a moving amount of the third enclosure accompanying the movement of the second enclosure to zero or to be smaller than a moving amount of the second enclosure, and
when the second enclosure moves to the third position from the first position, the joint mechanism causes the first operation part to be exposed in an operable state by restricting the moving amount of the third enclosure accompanying the movement of the second enclosure to be the same as that of the second enclosure or to be smaller than the moving amount of the second enclosure.

10. The portable device according to claim 9,
wherein the joint mechanism is constituted so that
when the second enclosure moves to the second position from the first position with respect to the first enclosure, second enclosure moves parallel in a first direction, and
when the second enclosure moves to the third position from the first position with respect to the first enclosure, the second enclosure moves parallel in a second direction differing from the first direction.

11. The portable device according to claim 10,
wherein the joint mechanism uses a parallel-linking mechanism as a mechanism for the second enclosure to perform parallel movement in one direction of parallel movement in two directions that are the first direction and the second direction.

12. The portable device according to claim 9,
wherein the joint mechanism is constituted so that
when the second enclosure moves to the second position from the first position with respect to the first enclosure, the second enclosure performs parallel movement, and
when the second enclosure moves to the third position from the first position with respect to the first enclosure, the second enclosure performs rotational movement.

13. The portable device according to claim 12, further comprising a restriction mechanism restricting movement of the second enclosure,
wherein the restriction mechanism restricts the motion of the second enclosure so as to
allow parallel movement and rotational movement of the second enclosure in the first position,
allow only the parallel movement of the second enclosure in the second position, and
allow only the rotational movement of the second enclosure in the third position.

14. The portable device according to claim 9,
wherein the joint mechanism is constituted so that
when the second enclosure moves to the second position from the first position with respect to the first enclosure, the second enclosure performs rotational movement, and
when the second enclosure moves to the third position from the first position with respect to the first enclosure, the second enclosure performs parallel movement.

15. The portable device according to claim 14, further comprising a restriction mechanism restricting movement of the second enclosure,
wherein the restriction mechanism restricts motion of the second enclosure so as to
allow parallel movement and rotational movement of the second enclosure in the first position,
allow only rotational movement of the second enclosure in the second position, and
allow only parallel movement of the second enclosure in the third position.

16. The portable device according to claim 9, further comprising:
a stop mechanism stopping the second enclosure with predetermined holding forces respectively in the first position, the second position and the third position.

17. A portable device, comprising:
a first enclosure including a first operation part;
a second enclosure including a display part;
a third enclosure;
a joint mechanism which joints the first enclosure, the second enclosure and the third enclosure respectively, and joints the second enclosure movably with respect to the first enclosure from a first position in which a silhouette of the second enclosure is overlaid on the first enclosure to a second position and a third position differing from each other;
a position detecting device capable of detecting which position of the first position, the second position and the third position the portable device is in; and
a mode selecting device selecting a usable operation mode from a plurality of operation modes, wherein
in the first position, the joint mechanism integrally joints the second enclosure so as to be overlaid on silhouettes of the first enclosure and the third enclosure,
when the second enclosure moves to the second position from the first position, the joint mechanism causes the third enclosure to be exposed by restricting a moving amount of the third enclosure accompanying the movement of the second enclosure to zero or to be smaller than a moving amount of the second enclosure, and
when the second enclosure moves to the third position from the first position, the joint mechanism causes the first operation part to be exposed in an operable state by restricting the moving amount of the third enclosure accompanying the movement of the second enclosure to be the same as that of the second enclosure or to be smaller than the moving amount of the second enclosure, and
wherein the mode selecting device automatically selects a usable operation mode from the plurality of operation modes based on a detection result of the position detecting device.

18. The portable device according to claim 17,
wherein the display part is provided in the second enclosure so that its longitudinal direction corresponds to a longitudinal direction of the second enclosure,
one of the plurality of operation modes is a television viewing and listening mode, a moving image reproduction mode or a game mode, and
when a screen of the display part is held to be seen horizontally, the first operation part exposed below the screen is a television operation part, a moving image reproduction operation part or a game operation part.

19. The portable device according to claim 17, further comprising:
a camera device which takes an image of a subject; and
an image-taking lens used in the camera device exposed from a back of the second enclosure only when the second enclosure is moved parallel in a longitudinal direction,
wherein the mode selecting device makes it possible to select a camera mode actuating the camera device only when the second enclosure is in the second position to which the second enclosure is moved parallel in the longitudinal direction.

20. The portable device according to claim 17, further comprising a telephone device,
wherein when the second enclosure is in the first position, the mode selecting device selects a waiting mode waiting for arrival of a telephone call from the plurality of operation modes, and
only when the second enclosure is in the second position to which the second enclosure is moved parallel in the longitudinal direction, the mode selecting device makes it possible to select a call mode allowing a call by the telephone device.
